(19) United States
(12) Patent Application Publication
(10) Pub. No.: US 2025/0017816 A1
(43) Pub. Date: Jan. 16, 2025

(54) MASSAGER

(71) Applicant: FENG JIN, Huizhou (CN)

(72) Inventor: FENG JIN, Huizhou (CN)

(21) Appl. No.: 18/350,113

(22) Filed: Jul. 11, 2023

(51) Int. Cl. A61H 23/02

(52) U.S. Cl. CPC A61H 23/0254; A61H 2201/0107; A61H 2201/0192; A61H 2201/50

(57) ABSTRACT

The present application discloses a massager, which relates to the field of health care products, and comprises a silicone body and a massaging assembly accommodated in the silicone body; the silicone body comprises a main body massaging part and a rolling massaging part connected to the main body massaging part. The massager of the present application realizes dual-point vibration and also has a rolling effect, so that the massage effect is better.

### TECHNICAL FIELD

The present application relates to the technical field of health products, specifically a massager.

### BACKGROUND

Health care refers to the effective measures taken to maintain and improve people's physical and mental health, including the prevention of various mental diseases caused by work, life, environment, etc. or various physical diseases caused by mental factors. Although it cannot directly improve the individual's mental health level, it can prevent the occurrence of unhealthy psychology and behavior of the individual.

A factor in what psychologists identify as a two-factor theory. According to this theory, an individual's work is influenced by two types of factors: one is the factor that can make people feel satisfied, it can affect people's work enthusiasm, and can motivate individuals to do their best; the second is the hygiene factor, also known as the “maintenance factor”, referring to the factors that can only prevent people from dissatisfaction, it does not act as an incentive. It is a necessary condition for maintaining people's mental health and avoiding setbacks. It is preventive and can maintain people's enthusiasm and work status. Rolling vibrating rod is one of the very important products in the field of health care.

Current massagers for adults generally only have single-point stretching, rotating or vibrating functions, and these functions cannot be close to the massaged parts of the human body, and thus cannot better meet the needs of users for massage experience.

To sum up, how to effectively solve the problem that the vibrating rod sticks to the massaged part of the human body and improve the user's massage experience is an urgent problem to be solved by those skilled in the art.

### SUMMARY

### I. To be Solved Technical Problem

Aiming at the deficiencies in the prior art, this application provides a massager, which solves the problem that current adult massagers generally only have single-point stretching, rotating or vibrating functions, and such functions cannot be close to the massage parts of the human body, and thus it cannot better meet the user's demand for massage experience.

### II. Technical Solution

In order to achieve the above purpose, the present application is achieved through the following technical solutions:

A massager, comprising a silicone body and a massaging assembly accommodated in the silicone body; the silicone body comprises a main body massaging part and a rolling massaging part connected with the main body massaging part.

Preferably, the main massaging part is detachably connected to the rolling massaging part.

Preferably, the rolling massaging part comprises a stretching and rolling connector and a first massaging end; one end of the stretching and rolling connector is detachably connected to the main body massaging part, and an other end is connected to the first massaging end; wherein when the stretching and rolling connector is stretched, it approaches the main body massaging part, and when the stretching and rolling connector is rolled and deformed, it is rolled away from the main body massaging part.

Preferably, the other end of the stretching and rolling connector is detachably connected to the first massaging end.

Preferably, the first massaging end has at least one of the following massage modes, vibrating massage, stretching massage, rotating massage, and tapping massage.

Preferably, the main body massaging part comprises a second massaging end.

Preferably, the second massaging end has at least one of the following massage modes, vibrating massage, stretching massage, rotating massage, and tapping massage.

Preferably, the main body massaging part further comprises a gripping end and a fixed connector; two ends of the fixed connector are respectively connected to the gripping end and the second massaging end.

Preferably, the massaging assembly is a vibration massaging assembly.

Preferably, the vibration massaging assembly comprises: a rechargeable lithium battery, a control circuit board, a charging stand, a keypad, a first vibration motor and a second vibration motor; wherein the charging stand is electrically connected to the rechargeable lithium battery, the rechargeable lithium battery is electrically connected to the control circuit board, and the keypad is connected to the control circuit board; wherein the control circuit board is connected to the first vibration motor and the second vibration motor respectively;
wherein the first vibration motor is accommodated in the second massaging end, and the second vibration motor is accommodated in the first massaging end.

Preferably, the main body massaging part is formed by detachable splicing of a first silicone shell and a second silicone shell.

Preferably, the first silicone shell and the second silicone shell are detachably connected by a screw assembly.

Preferably, the first silicone shell defines a first accommodation cavity, and the first vibration motor is detachably fixed in the first accommodation cavity.

Preferably, the first silicone shell is provided with a second accommodation cavity, and one or more of the charging stand, the rechargeable lithium battery and the keypad are stored in the second accommodation cavity.

Preferably, the first massaging end is formed by detachable splicing of a third silicone shell and a fourth silicone shell.

Preferably, the third silicone shell and the fourth silicone shell are detachably connected by a screw assembly.

Preferably, the charging stand is accommodated in the second accommodation cavity, and one end of the charging stand extending out of the first silicone shell is covered with a waterproof plug.

Preferably, after assembly of the massaging assembly and the silicone body is completed, a liquid full-coating is carried out.

The present application discloses a massager, which has the following beneficial effects:

1. The structure of the massager is simple and the design is reasonable, so that the massager can realize the functions of stimulating massage and rolling at the same time, making the massager close to the massage parts of the human body, which greatly enhances the experience of using the massager.

2. The waterproof plug provided on the massager can protect the position of the interface when the massager is not charging, thereby preventing the internal components of the massager from being damaged by moisture.

3. On the massager, two switch buttons are set to independently control the ON and OFF of the first vibration motor and the second vibration motor, so as to realize different massage modes. The four function buttons are set can realize the adjustment of the vibration intensity of the first vibration motor and the second vibration motor, so as to realize different massage intensity experiences and ensure a good massage experience effect.

4. The massager realizes dual-point massage, which greatly enhances the user experience of the massager.

### BRIEF DESCRIPTION OF DRAWINGS

In order to more clearly illustrate the technical solutions in the embodiments of the present application or the prior art, the following briefly introduces the drawings that are required in the description of the embodiments or the prior art. Apparently, the drawings in the following description are only some embodiments of the present application, and those skilled in the art can obtain other drawings according to these drawings without creative efforts.

FIG. 1 is a schematic diagram before rolling of the massager of the present application;

FIG. 2 is a schematic diagram after rolling of the massager of the present application;

FIG. 3 is another schematic diagram of the massager shown in FIG. 1;

FIG. 4 is an exploded diagram of the massager shown in FIG. 3;

FIG. 5 is a partially enlarged diagram of the massager shown in FIG. 4;

FIG. 6 is an enlarged diagram at A of FIG. 3;

FIG. 7 is an enlarged diagram at B of FIG. 3.

### DETAILED DESCRIPTION

In order to make the purpose, technical solutions and advantages of the embodiments of the present application clearer, the technical solutions in the embodiments of the present application are clearly and completely described. Apparently, the described embodiments are some of the embodiments of the present application, but not all of them. Based on the embodiments in the present application, all other embodiments obtained by persons of ordinary skill in the art without creative efforts fall within the protection scope of the present application.

The embodiment of the present application provides a massager to solve the problem that the current adult massagers generally only have the functions of stretching, rotating and vibrating, and such functions cannot be close to the massage parts of the human body, and thus cannot better meet the needs of users for massage experience. The overall structure of the present application is simple and the design is reasonable. Only one main body massaging part and one rolling massaging part are needed, so that the massager can simultaneously realize the functions of stimulating massage and rolling, making the massager close to the massage parts of the human body, which greatly enhances the use of the massager sense of experience.

In order to better understand the above-mentioned technical solution, the above-mentioned technical solution will be described in detail below in conjunction with the accompanying drawings and specific implementation methods.

### Embodiment

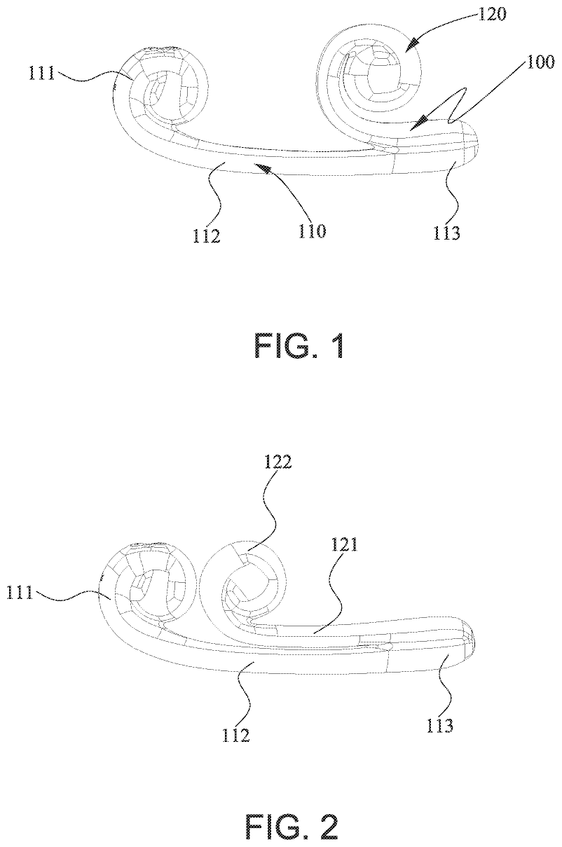

The embodiment of the present application discloses a massager, as shown in FIG. 1, comprising a silicone body 100 and a massage assembly accommodated in the silicone body 100. The silicone body 100 comprises a main body massaging part 110 and a rolling massaging part 120 connected with the main body massaging part 110. As a preferred embodiment, the main body massaging part 110 is detachably connected to the rolling massaging part 120.

As shown in FIG. 2, the rolling massaging part 120 comprises a stretching and rolling connector 121 and a first massaging end 122. One end of the stretching and rolling connector 121 is detachably connected to the main body massaging part 110, and an other end is connected to the first massaging end 122. When the stretching and rolling connector 121 is stretched, it approaches the main body massaging part 110, and when the stretching and rolling connector 121 is rolled and deformed, it is rolled away from the main body massaging part 110. Specifically, the other end of the stretching and rolling connector 121 is detachably connected to the first massaging end 122. Preferably, both ends of the stretching and rolling connector 121 are detachably connected to the main body massaging part 110 and the first massaging end 122 respectively through buckling.

It should be noted that the first massaging end 122 has at least one of the following massage modes, vibrating massage, stretching massage, rotating massage, and tapping massage. For example, one of vibrating massage, stretching massage, rotating massage or flapping massage can be used alone. You can also use the combination of vibrating massage and stretching massage, the combination of vibrating massage and rotating massage, the combination of vibrating massage and tapping massage, the combination of stretching massage and rotating massage, the combination of stretching massage and tapping massage; the combination of rotating massage and tapping massage; you can also use the combination of vibrating massage, stretching massage and rotating massage; you can also use the combination of vibrating massage, stretching massage and tapping massage; you can also use the combination of stretching massage, rotating massage and tapping massage; you can also use the combination of vibrating massage, stretching massage, rotating massage and tapping massage.

In this embodiment, the first massaging end 122 adopts a vibrating massage method.

As shown in FIG. 2, the main body massaging part 110 comprises a second massaging end 113.

It should be noted that the second massaging end 123 has at least one of the following massage modes, vibrating massage, stretching massage, rotating massage, and tapping massage. For example, one of vibrating massage, stretching massage, rotating massage or flapping massage can be used alone. You can also use the combination of vibrating massage and stretching massage, the combination of vibrating massage and rotating massage, the combination of vibrating massage and tapping massage, the combination of stretching massage and rotating massage, the combination of stretching massage and tapping massage; the combination of rotating massage and tapping massage; you can also use the combination of vibrating massage, stretching massage and rotating massage; you can also use the combination of vibrating massage, stretching massage and tapping massage; you can also use the combination of stretching massage, rotating massage and tapping massage; you can also use the combination of vibrating massage, stretching massage, rotating massage and tapping massage.

In this embodiment, the second massaging end 113 adopts a vibrating massage method.

As shown in FIG. 2, in this embodiment, the main body massaging part 110 further comprises a gripping end 111 and a fixed connector 112. Two ends of the fixed connector 112 are respectively connected to the gripping end 111 and the second massaging end 113.

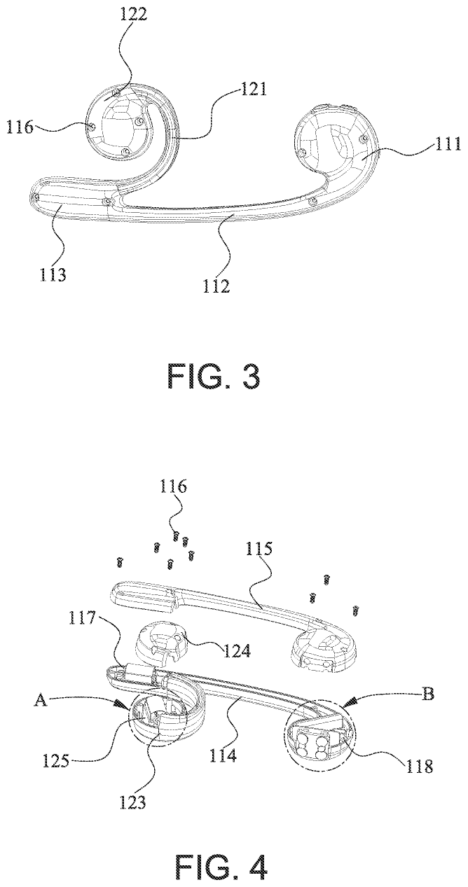

As shown in FIG. 2 and FIG. 3, the stretching and rolling connector 121 is snap-connected with the fixed connector 112. The stretching and rolling connector 121 is snap-connected with the first massaging end 122.

In this embodiment, the massaging assembly is a vibration massaging assembly.

As shown in FIG. 4-7, the massaging assembly comprises: a rechargeable lithium battery 210, a control circuit board 220, a charging stand 230, a keypad 240, a first vibration motor 250 and a second vibration motor 260. The charging stand 230 is electrically connected to the rechargeable lithium battery 210, the rechargeable lithium battery 210 is electrically connected to the control circuit board 220. The keypad 240 is connected to the control circuit board 220. The control circuit board 240 is connected to the first vibration motor 250 and the second vibration motor 260 respectively. The keypad 240 has two switch buttons, and the two switch buttons respectively control the first vibration motor 250 and the second vibration motor 260 through the control circuit board 220 in a one-to-one correspondence. The keypad 240 also has 4 gear buttons, and the 4 gear buttons control the output gears of the first vibration motor 250 and the second vibration motor 260 through the control circuit board 220 respectively, so as to achieve the vibration intensity of the massager, so that the user can has a better sense of experience when using the massager.

As shown in FIG. 3 and FIG. 4, the first vibration motor 250 is accommodated in the second massaging end 113, and the second vibration motor 260 is accommodated in the first massaging end 122. By designing the massager with two vibration functions, the user experience is better.

As shown in FIG. 4, preferably, the main body massaging part 110 is formed by detachable splicing of a first silicone shell 114 and a second silicone shell 115. In this embodiment, the first silicone shell 114 and the second silicone shell 115 are detachably connected by a screw assembly 116. The first silicone shell 114 and the second silicone shell 115 are detachably spliced, thereby making the assembly of the massager more convenient and efficient. Moreover, such a design makes it easier to maintain the massager when it breaks down.

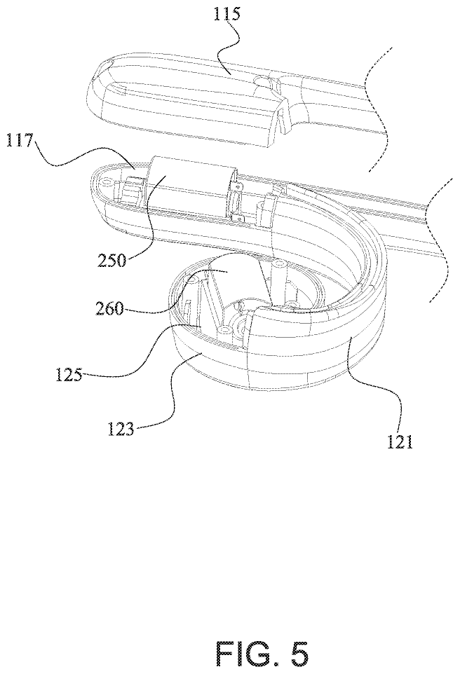

As shown in FIG. 4 and FIG. 5, the first silicone shell 114 is provided with a first accommodation cavity 117, and the first vibration motor 250 is detachably fixed in the first accommodation cavity 117, so that on the one hand, the first vibration motor 250 is firmly fixed, on the other hand, makes the assembly of the first vibration motor 250 more convenient and efficient.

As shown in FIG. 4 and FIG. 7, the first silicone shell 114 is provided with a second accommodation cavity 118, and the charging stand 230, the rechargeable lithium battery 210 and the keypad 240 are all stored in the second accommodation cavity 118, so that the structure of the massager is more compact, and the installation is more convenient and efficient. In addition, in this embodiment, the second accommodation cavity 118 is formed at the gripping end 111. When the assembly is completed, the buttons of the keypad 240 protrudes from the gripping end, on the one hand, it is convenient for the user to adjust the switch and vibration intensity of the first vibration motor 250 and the second vibration motor 260 at any time during the use of the massager; on the other hand, the structure of the massager is more compact and the appearance is more beautiful.

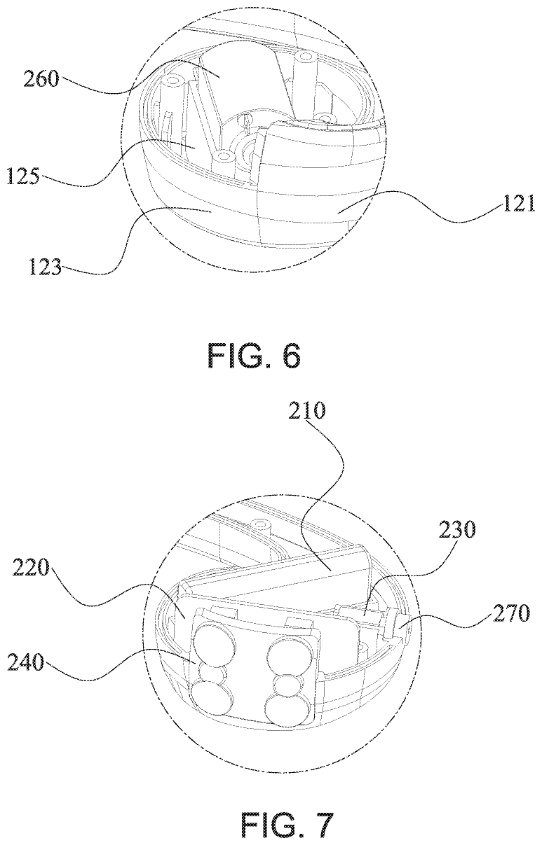

As shown in FIG. 4, FIG. 5 and FIG. 6, the first massaging end 122 is formed by detachable splicing of a third silicone shell 123 and a fourth silicone shell 124. In this embodiment, the third silicone shell 123 and the fourth silicone shell 124 are detachably connected by a screw assembly 116. The third silicone shell 123 and the fourth silicone shell 124 are detachably spliced, thereby making the assembly of the massager more convenient and efficient. Moreover, such a design makes it easier to maintain the massager when it breaks down. The third silicone shell 123 is provided with a third accommodation cavity 125, and the second vibration motor 260 is detachably fixed in the third accommodation cavity 125, so that on the one hand, the second vibration motor 260 is firmly fixed, and on the other hand, the second vibration motor 260 is firmly fixed. The assembly of the second vibration motor 260 is more convenient and efficient.

As shown in FIG. 4 and FIG. 7, in this embodiment, the charging stand 230 is accommodated in the second accommodation cavity 118, and the end of the charging stand 230 extending out of the first silicone shell 114 is covered with a waterproof plug 270. The waterproof plug 270 protects the charging interface, prevents moisture in the air from entering the interior of the massager, and prevents the internal components of the massager from being damaged by moisture or reducing the lifespan.

As shown in FIG. 1 and FIG. 2, specifically, the rolling massaging part 120 is made of high elastic rubber. During use, as the second massaging end 113 gradually comes into contact with the massage position, the first massaging end 122 will have a push force when it comes into contact with the massage position and forms a squeeze, thereby indirectly causing the stretching and rolling connector 121 stretches gradually.

In this embodiment, after the vibration massaging assembly and the silicone body 100 are assembled, a liquid full-coating is carried out, which on the one hand makes the massager more beautiful, and on the other hand makes the use experience of the massager better.

The massager of the present application realizes dual-point stimulation massage and also has a rolling effect, so that the massage effect is better.

Please refer to FIG. 1 to FIG. 7 together, one of the working modes of the massager of the present application is: When using this massager, it needs to be charged at first; when using it, first selecting the required massage mode through the button; touching the massage position; in the process of pushing the massager, the first massaging end 122 gradually contacts the massage position; at the same time, the first massaging end 122 forms a squeeze with the massage position, thereby indirectly pushing the stretching and rolling connector 121 to gradually stretch; when the second massaging end 113 gradually moves away from the massage position, the massage position gradually disappears to the first massaging end 122. At this time, the stretching and rolling connector 121 performs rolling deformation reset under its own elastic force.

When charging, removing the waterproof plug 270 and inserting the charging connector into the charging stand 230; When the rechargeable lithium battery 210 is fully charged, unplugging the charging connector, and plugging the waterproof plug 270 into the charging stand 230.

Specifically, the keypad 240 is used to control the electrical connection between the rechargeable lithium battery 210 and the first vibration motor 250 and the second vibration motor 260, so as to control the operation or stop of the first vibration motor 250 and the second vibration motor 260, so that the massage has different modes. The keypad 240 also controls the vibration intensity of the first vibration motor 250 and the second vibration motor 260 through the control circuit board 220, so that the massage has different intensity modes.

It should be noted that in this article, relational terms such as first and second are only used to distinguish one entity or operation from another entity or operation, and do not necessarily require or imply that there is a relationship between these entities or operations. There is no such actual relationship or order between them. The term “comprises”, “includes” or any other variation thereof is intended to cover a non-exclusive inclusion such that a process, method, article or apparatus comprising a set of elements includes not only those elements but also other elements not expressly listed elements, or also elements inherent in such a process, method, article, or apparatus. Without further limitations, an element defined by the phrase “comprising a . . . ” does not exclude the presence of additional identical elements in the process, method, article or apparatus comprising said element.

The basic principles and main features of the present application and the advantages of the present application have been shown and described above. Those skilled in the art should understand that the present application is not limited by the above-mentioned embodiments, and what is described in the above-mentioned embodiments and description only illustrates the principle of the present application. On the premise of not departing from the spirit and scope of the present application, there will be various changes and improvements in the present application, and these changes and improvements all fall within the scope of the claimed application. The protection scope required in this application is defined by the appended claims and their equivalents.

What is claimed is:

1. A massager, comprising a silicone body and a massaging assembly accommodated in the silicone body; the silicone body comprises a main body massaging part and a rolling massaging part connected with the main body massaging part.

2. The massager according to claim 1, wherein the main massaging part is detachably connected to the rolling massaging part.

3. The massager according to claim 1, wherein the rolling massaging part comprises a stretching and rolling connector and a first massaging end; one end of the stretching and rolling connector is detachably connected to the main body massaging part, and an other end is connected to the first massaging end; wherein when the stretching and rolling connector is stretched, it approaches the main body massaging part, and when the stretching and rolling connector is rolled and deformed, it is rolled away from the main body massaging part.

4. The massager according to claim 3, wherein the other end of the stretching and rolling connector is detachably connected to the first massaging end.

5. The massager according to claim 3, wherein the first massaging end has at least one of the following massage modes, vibrating massage, stretching massage, rotating massage, and tapping massage.

6. The massager according to claim 1, wherein the main body massaging part comprises a second massaging end.

7. The massager according to claim 6, wherein the second massaging end has at least one of the following massage modes, vibrating massage, stretching massage, rotating massage, and tapping massage.

8. The massager according to claim 6, wherein the main body massaging part further comprises a gripping end and a fixed connector; two ends of the fixed connector are respectively connected to the gripping end and the second massaging end.

9. The massager according to claim 1, wherein the massaging assembly is a vibration massaging assembly.

10. The massager according to claim 9, wherein the vibration massaging assembly comprises: a rechargeable lithium battery, a control circuit board, a charging stand, a keypad, a first vibration motor and a second vibration motor; wherein the charging stand is electrically connected to the rechargeable lithium battery, the rechargeable lithium battery is electrically connected to the control circuit board, and the keypad is connected to the control circuit board; wherein the control circuit board is connected to the first vibration motor and the second vibration motor respectively;
wherein the first vibration motor is accommodated in the second massaging end, and the second vibration motor is accommodated in the first massaging end.

11. The massager according to claim 10, wherein the main body massaging part is formed by detachable splicing of a first silicone shell and a second silicone shell.

12. The massager according to claim 11, wherein the first silicone shell and the second silicone shell are detachably connected by a screw assembly.

13. The massager according to claim 11, wherein the first silicone shell defines a first accommodation cavity, and the first vibration motor is detachably fixed in the first accommodation cavity.

14. The massager according to claim 11, wherein the first silicone shell is provided with a second accommodation cavity, and one or more of the charging stand, the rechargeable lithium battery and the keypad are stored in the second accommodation cavity.

15. The massager according to claim 10, wherein the first massaging end is formed by detachable splicing of a third silicone shell and a fourth silicone shell.

16. The massager according to claim 15, wherein the third silicone shell and the fourth silicone shell are detachably connected by a screw assembly.

17. The massager according to claim 14, wherein the charging stand is accommodated in the second accommodation cavity, and one end of the charging stand extending out of the first silicone shell is covered with a waterproof plug.

18. The massager according to claim 1, wherein after assembly of the massaging assembly and the silicone body is completed, a liquid full-coating is carried out.
